(19) United States
(12) Patent Application Publication
(10) Pub. No.: US 2023/0060016 A1
(43) Pub. Date: Feb. 23, 2023

(54) RECYCLED POLYETHYLENE TEREPHTHALATE COMPOSITION

(71) Applicant: Duraflex Hong Kong Limited, Hong Kong (CN)

(72) Inventors: Hing Lun LEUNG, Hong Kong (CN); Hei Nga LEUNG, Hong Kong (CN)

(73) Assignee: Duraflex Hong Kong Limited, Hong Kong (CN)

(21) Appl. No.: 17/392,317

(22) Filed: Aug. 3, 2021

(51) Int. Cl. B29C 45/00; C08K 5/098; C08K 5/353; C08L 67/02; C08K 5/00

(52) U.S. Cl. CPC B29C 45/0001; C08K 5/098; C08K 5/353; C08L 67/02; C08K 5/0041; C08K 5/0083; C08K 5/005; B29L 2019/00

(57) ABSTRACT

A composition for production of injection-molded articles is made of recycled polyethylene terephthalate in an amount of over 90 wt %, a nucleation agent selected from salts of citrate acid, salts of carbonic acid, titanium oxide and mixtures thereof in an amount of 0.2-1 phr, and an impact modifier in the form of an unsaturated organic compound selected from acids, anhydrides, esters and metallic salts of at least one of the following: maleic, acrylic, methacrylic, itaconic, crotonic, alpha-methyl crotonic and cinnamic, in an amount of 2-4 phr. Optical brighteners, heat stabilizers and wax can also be added. The composition has high tensile strength, low shrinkage and high color stability, especially when compared to pure RPET.

### BACKGROUND OF THE INVENTION

### 1. Field of the Invention

The invention relates generally to recycled polyethylene terephthalate (PET) compositions, which is a suitable material for producing apparel accessories, such as button, zipper puller, cord lock, cord end, stopper, etc. In the industry of apparel accessories, there is a need to use recycled polyethylene terephthalate to produce apparel accessories to achieve better sustainability market need.

### 2. The Prior Art

In the apparel accessory industry, recycled polyethylene terephthalate (RPET) is highly desirable for the production of different apparel accessories, such as buttons, zipper pullers, cord locks, cord ends, stoppers, etc. to achieve better sustainability.

However, pure RPET is not suitable for injection molding due to: very long cycle times, mold sticking problems, sink marks, etc. In addition, during injection molding, RPET becomes increasingly yellow, which indicates color instability. The instability of the color in the molded material makes the use of pure RPET to produce apparel accessories in various colors very difficult.

Commercialized PET material that is sold for injection molding seldom contains recycled content. Those commercial grades that contain recycled content usually contain glass fibers/minerals/inorganic fibers. Glass fiber would be exposed on the surface of the molded part, which causes cosmetic defects. Furthermore, it is undesirable to use glass fiber in the industry of apparel accessories because of the potential “dangerous image” to have glass on clothes.

Thus, there is a need to provide a modified recycled PET material without glass or inorganic fibers, and which is suitable for the production of apparel accessories via injection molding.

### SUMMARY OF THE INVENTION

This object is accomplished according to the invention by a recycled PET product that contains a combination of RPET, virgin PET and other ingredients to create a product that is suitable for injection molding, color-stable, and glass-free.

The composition according to the invention is made of the following components, in combination with the percentages given by weight % of RPET of the entire composition, and phr (parts per hundred resin of RPET) for the other components:

1. Recycled Polyethylene Terephthalate, from any source, including mechanical recycling, chemical recycling, or biochemical recycling. The RPET can be bright or semi-dull, in an amount of >90 wt %.

2. Virgin Polyethylene Terephthalate, in the form of homopolymer or copolymer, with intrinsic viscosity larger than 1.0 dL/g in an amount of 0-7 phr.

3. A nucleation agent selected from salts of citrate acid (anhydrous or dihydrate), or salts of carbonic acid (untreated or treated with stearic acid), titanium oxide and mixtures thereof in an amount to 0.2-1 phr.

4. An impact modifier in the form of an unsaturated organic compound selected from the group consisting of maleic, acrylic, methacrylic, itaconic, crotonic, alpha-methyl crotonic and cinnamic acids, anhydrides, esters and their metal salts. Examples are: EMA-GMA (ethylene-methyl acrylate-glycidyl methacrylate terpolymer), PP-g-MAH (polypropylene grafted maleic anhydride), PE-g-MAH (Polyethylene grafted maleic anhydride), POE-g-MAH (functionalized polyolefin elastomer grafted maleic anhydride), and their mixture, in an amount of 2-4 phr.

5. An optical brightener in the form of a compound having at least four conjugated double bonds, such as —C═C—C═C—C═C—C═C— or —N═C—C═C—C═N—C═C— in its molecule structure. Examples are 2,5-Bis(5-tert-butyl-2-benzoxazolyl)thiophene, 4,4′-Bis(5-methyl-2-benzoxazolyl)stilbene, 2,2′-(1,2-Ethenediyldi-4,1-phenylene)bisbenzoxazole, 1-(2-Cyanostyryl)-4-(4-cyanostyryl)benzene, 4,4-Bis(diethylphosphonomethyl)biphenyl, Disodium 4,4′-bis(2-sulfostyryl)biphenyl, and mixtures thereof, in an amount of 0-1 phr.

6. A heat stabilizer including primary antioxidants or secondary antioxidants in an amount of 0-0.2 phr. The primary antioxidants include hindered phenols and secondary aromatic amines. Examples are: Pentaerythritol tetrakis[3-[3,5-di-tert-butyl-4-hydroxyphenyl]propionate, octadecyl-3-[3,5-di-tert-butyl hydroxyphenyl]propionate], 3,3′,3′,5,5′,5′-hexa-tert-butyl-a,a′,a′-(mesitylene-2,4,6-triyl)tri-p-cresol, calcium-bis (((3,5-bis(1,1-dimethylethyl)-4-hydroxyphenyl)methyl)-ethylphosphonate), bis (oxyethylene) bis-(3-(5-tert-butyl-4-hydroxy-m-tolyl)-propionate), 3,5-bis (1,1-dimethyl-ethyl)-4-hydroxy-C7-C9 branched alkyl esters, and mixtures thereof.

The secondary antioxidants include phosphorus compounds. Examples are tris(2,4-ditert-butylphenyl)phosphite, Bis(2,4-di-tert-butylphenyl) Pentaerythritol Diphosphite, Tris(dipropyleneglycol) phosphite, Calcium bis[monoethyl(3,5-di-tert-butyl-4-hydroxylbenzyl)phosphonate], and mixtures thereof.

7. A wax, particularly a polyolefin based wax. Examples are: PE-wax, PP-wax, and mixtures thereof, in an amount of 0-1.5 phr.

The components listed above are mixed, melted and pelletized by extrusion. The pelletized composition is then placed in an injection molding machine to create the desired molded parts. The specific combinations of these components led to a composition that is suitable for use in injection molding, with short cycle times, low degree of sticking, and importantly, no yellowing. Molded parts for apparel can be made using the composition according to the invention, in particular zipper pullers, cord ends, cord locks, buttons or any other molded parts that could be made using PET.

### DETAILED DESCRIPTION OF THE EMBODIMENTS

The following will describe specific examples of RPET compositions according to the invention. The Examples are for illustration of various compositions within the scope of the invention and are not intended as a limitation of the claims. The compositions described in the examples are made by mixing the listed components, melting, pelletizing by extrusion and then placing them in an injection molding machine to mold various products that are then tested for strength, shrinkage and color.

In the examples, the following abbreviations are defined as follows:

RPET=Recycled Polyethylene Terephthalate

PET=Virgin Polyethylene Terephthalate

TiO₂=Titanium Oxide

NA=Nucleation Agent

IM=Impact modifier

OB=Optical brightener

Pri-HS=Primary Heat Stabilizer

Sec-HS=Secondary Heat Stabilizer

The amounts in each example are given as a percent by weight of RPET of the entire composition, and as PHR (parts per hundred resin) of the other components. The other components are defined as parts per hundred parts of RPET.

### EXAMPLE 1

RPET: 96.9 wt %

NA(trisodium citrate) 0.2 phr

IM(PE-g-MAH): 2.0 phr

OB: 1.0 phr

(2,2′-(1,2-Ethenediyldi-4,1-phenylene)bisbenzoxazole)

### EXAMPLE 2

RPET: 96.5 wt %

NA (trisodium citrate): 0.6 phr

IM (EMA-GMA): 2.0 phr

OB: 1.0 phr

(2,2′-(1,2-Ethenediyldi-4,1-phenylene)bisbenzoxazole)

### EXAMPLE 3

RPET: 91.7 wt %

PET: 5.0 phr

NA (trisodium citrate): 1.0 phr

IM (PP-g-MAH): 2.0 phr

OB: 1.0 phr

(2,2′-(1,2-Ethenediyldi-4,1-phenylene)bisbenzoxazole)

### EXAMPLE 4

RPET: 90.1 wt %

PET: 5.0 phr

NA(trisodium citrate): 1.0 phr

IM (PP-g-MAH): 4.0 phr

OB: 1.0 phr

(2,2′-(1,2-Ethenediyldi-4,1-phenylene)bisbenzoxazole)

### EXAMPLE 5

RPET: 90.1 wt %

PET: 7.0 phr

NA (trisodium citrate): 1.0 phr

IM (PP-g-MAH): 2.0 phr

OB: 1.0 phr

(2,2′-(1,2-Ethenediyldi-4,1-phenylene)bisbenzoxazole)

### EXAMPLE 6

RPET: 90.3 wt %

PET: 7.0 phr

TiO₂: 0.3 phr

NA (trisodium citrate): 1.0 phr

IM (PP-g-MAH): 2.0 phr

### EXAMPLE 7

RPET: 90.2 wt %

PET: 7.0 phr

NA (trisodium citrate): 1.0 phr

IM (PP-g-MAH): 2.0 phr

Pri-HS: 0.2 phr

(Pentaerythritol tetrakis[3-[3,5-di-tert-butyl-4-hydroxyphenyl]propionate)

Sec-HS: 0.2 phr

(tris(2,4-ditert-butylphenyl)phosphite)

Wax (PE): 0.5 phr

### EXAMPLE 8

RPET: 90.3 wt %

PET: 7.0 phr

TiO₂: 0.3 phr

NA (CaCO₃) 1.0 phr

IM (PP-g-MAH): 2.0 phr

Pri-HS: 0.2 phr

(Pentaerythritol tetrakis[3-[3,5-di-tert-butyl-4-hydroxyphenyl]propionate)

Sec-HS: 0.2 phr

(tris(2,4-ditert-butylphenyl)phosphite)

### EXAMPLE 9

RPET: 95.1 wt %

TiO₂: 0.3 phr

NA (trisodium citrate) 1.0 phr

IM (PP-g-MAH): 2.0 phr

Pri-HS: 0.2 phr

(Pentaerythritol tetrakis[3-[3,5-di-tert-butyl-4-hydroxyphenyl]propionate)

Sec-HS: 0.2 phr

(tris(2,4-ditert-butylphenyl)phosphite)

Wax (PE-wax) 1.5 phr

The compositions are set forth in the table 1 below:

| | RPET | | PET | TiO₂ | NA | NA | IM | IM | IM |
|---|---|---|---|---|---|---|---|---|---|
| | Detailed components | | | | | | | | |
| | Recycled Polyethylene | | Homopolymer | | Trisodium | | PP-g- | PE-g- | EMA- |
| | Terephthalate | | (IV = 1.2) | TiO₂ | Citrate | CaCO₃ | MAH | MAH | GMA |
| | Unit | | | | | | | | |
| | % | phr | phr | phr | phr | phr | phr | phr | phr |
| Reference | 100 | 100 | | | | | | | |
| Example 1 | 96.9 | 100 | 0 | 0 | 0.2 | 0 | 0 | 2 | 0 |
| Example 2 | 96.5 | 100 | 0 | 0 | 0.6 | 0 | 0 | 0 | 2 |
| Example 3 | 91.7 | 100 | 5 | 0 | 1 | 0 | 2 | 0 | 0 |
| Example 4 | 90.1 | 100 | 5 | 0 | 1 | 0 | 4 | 0 | 0 |
| Example 5 | 90.1 | 100 | 7 | 0 | 1 | 0 | 2 | 0 | 0 |
| Example 6 | 90.3 | 100 | 7 | 0.3 | 1 | 0 | 2 | 0 | 0 |
| Example 7 | 90.2 | 100 | 7 | 0 | 1 | 0 | 2 | 0 | 0 |
| Example 8 | 90.3 | 100 | 7 | 0.3 | 0 | 1 | 2 | 0 | 0 |
| Example 9 | 95.1% | 100 | 0 | 0.3 | 1 | 0 | 2 | 0 | 0 |

| | OB | Pri-HS | Sec-HS | Wax |
|---|---|---|---|---|
| | Detailed components | | | |
| | 2,2′-(1,2- | Pentaerythritol tetrakis[3- | | |
| | Ethenediyldi-4,1- | [3,5-di-tert-butyl-4- | tris(2,4-ditert- | |
| | phenylene)bisbenzoxazole | hydroxyphenyl]propionate | butylphenyl)phosphite | PE-wax |
| | Unit | | | |
| | phr | phr | phr | phr |
| Reference | | | | |
| Example 1 | 1 | 0 | 0 | 0 |
| Example 2 | 1 | 0 | 0 | 0 |
| Example 3 | 1 | 0 | 0 | 0 |
| Example 4 | 1 | 0 | 0 | 0 |
| Example 5 | 1 | 0 | 0 | 0 |
| Example 6 | 0 | 0 | 0 | 0 |
| Example 7 | 0 | 0.2 | 0.2 | 0.5 |
| Example 8 | 0 | 0.2 | 0.2 | 0 |
| Example 9 | 0 | 0.2 | 0.2 | 1.5 |

Each of the compositions was tested for tensile strength, shrinkage in the mold, and color. The results are listed in Table 2 below:

TABLE 2

| | Tensile | Shrinkage | |
|---|---|---|---|
| | Strength kg | (sink mark) | Color |
| Reference | 2.07 | Serious | inconsistently yellowish |
| Example 1 | 4.8 | No | consistently bluish white |
| Example 2 | 22.2 | No | consistently bluish white |
| Example 3 | 7.1 | No | consistently bluish white |
| Example 4 | 8.2 | No | consistently bluish white |
| Example 5 | 28.7 | No | consistently bluish white |
| Example 6 | 5.6 | No | consistently creamy white |
| Example 7 | 6.54 | No | consistently creamy white |
| Example 8 | 5.67 | No | consistently creamy white |
| Example 9 | 11.28 | No | consistently creamy white |

As can be seen from Table 2, the products produced according to the invention exhibit no serious shrinkage, evidenced by sink marks, little yellowing, and high tensile strength, especially when compared to a reference sample of pure RPET, which is yellowish, exhibits serious shrinkage and has a significantly lower tensile strength as compared to the compositions according to the invention.

The compositions according to the invention have many advantages, especially when compared to pure RPET or virgin PET.

The present invention has the advantage of being made with >90% Recycled content, and greater than 95% content of polyethylene terephthalate. The compositions are highly suitable for injection molding, yielding a cycle time within 20 seconds. The compositions of the present invention exhibit low shrinkage and improving sink marks when comparing to 100% recycled PET.

In addition, the compositions of the present invention make RPET processable by injection molding without requiring the addition of glass, minerals or inorganic fibers, yet is still able to be colored to commercial standards.

Furthermore, the compositions according to the invention have increased tensile strength of between 2 and 14 times that of 100% recycled PET as well as increased color stability when compared to 100% recycled PET. The composition according to the present invention avoids the use of any polymers that do not consist of hydrogen, oxygen, and carbon.

What is claimed is:

1. A composition configured for production of injection-molded articles, comprising:
(a) recycled polyethylene terephthalate in an amount of over 90 wt %;
(b) a nucleation agent selected from the group consisting of salts of citrate acid, salts of carbonic acid, titanium oxide and mixtures thereof in an amount of 0.2-1 phr, and
(c) an impact modifier in the form of an unsaturated organic compound selected from the group consisting of acids, anhydrides, esters and metallic salts of at least one of the following: maleic, acrylic, methacrylic, itaconic, crotonic, alpha-methyl crotonic and cinnamic, in an amount of 2-4 phr.

2. The composition according to claim 1, further comprising virgin polyethylene terephthalate in an amount of up to 7 phr.

3. The composition according to claim 1, further comprising an optical brightener in the form of a compound having at least four conjugated double bonds in an amount of up to 1 phr.

4. The composition according to claim 1, further comprising a heat stabilizer in the form of a primary antioxidant in the form of a hindered phenol or secondary aromatic amine, or a secondary antioxidant containing phosphorous in an amount of up to 0.5 phr.

5. The composition according to claim 1, further comprising a polyolefin-based wax in an amount of up to 1.5 phr.

6. The composition according to claim 1, wherein the composition consists of the following components:
RPET in an amount of 96.9 wt %,
Trisodium Citrate in an amount of 0.2 phr,
PE-g-MAH in an amount of 2.0 phr, and
2,2′-(1,2-Ethenediyldi-4,1-phenylene)bisbenzoxazole in an amount of 1.0 phr.

7. The composition according to claim 1, wherein the composition consists of the following components:
RPET in an amount of 96.5 wt %,
Trisodium Citrate in an amount of 0.6 phr,
EMA-GMA in an amount of 2.0 phr, and
2,2′-(1,2-Ethenediyldi-4,1-phenylene)bisbenzoxazole in an amount of 1.0 phr.

8. The composition according to claim 1, wherein the composition consists of the following components:
RPET in an amount of 91.7 wt %,
Virgin PET in an amount of 5 phr
Trisodium Citrate in an amount of 1.0 phr,
PP-g-MAH in an amount of 2.0 phr, and
2,2′-(1,2-Ethenediyldi-4,1-phenylene)bisbenzoxazole in an amount of 1.0 phr.

9. The composition according to claim 1, wherein the composition consists of the following components:
RPET in an amount of 90.1 wt %,
Virgin PET in an amount of 5 phr
Trisodium Citrate in an amount of 1.0 phr,
PP-g-MAH in an amount of 4.0 phr, and
2,2′-(1,2-Ethenediyldi-4,1-phenylene)bisbenzoxazole in an amount of 1.0 phr.

10. The composition according to claim 1, wherein the composition consists of the following components:
RPET in an amount of 90.1 wt %,
Virgin PET in an amount of 7 phr,
Trisodium Citrate in an amount of 1.0 phr,
PP-g-MAH in an amount of 2.0 phr, and
2,2′-(1,2-Ethenediyldi-4,1-phenylene)bisbenzoxazole in an amount of 1.0 phr.

11. The composition according to claim 1, wherein the composition consists of the following components:
RPET in an amount of 90.3 wt %,
Virgin PET in an amount of 7 phr
TiO₂ in an amount of 0.3 phr,
Trisodium Citrate in an amount of 1.0 phr,
PP-g-MAH in an amount of 2.0 phr.

12. The composition according to claim 1, wherein the composition consists of the following components:
RPET in an amount of 90.2 wt %,
Virgin PET in an amount of 7 phr,
Trisodium Citrate in an amount of 1.0 phr,
PP-g-MAH in an amount of 2.0 phr,
Pentaerythritol tetrakis[3-[3,5-di-tert-butyl-4-hydroxyphenyl]propionate) in an amount of 0.2 phr,
tris(2,4-ditert-butylphenyl)phosphite in an amount of 0.2 phr and
Polyethylene wax in an amount of 0.5 phr.

13. The composition according to claim 1, wherein the composition consists of the following components:
RPET in an amount of 90.3 wt %,
Virgin PET in an amount of 7 phr,
TiO₂ in an amount of 0.3 phr,
CaCO₃ in an amount of 1.0 phr,
PP-g-MAH in an amount of 2.0 phr,
Pentaerythritol tetrakis[3-[3,5-di-tert-butyl-4-hydroxyphenyl]propionate) in an amount of 0.2 phr, and
tris(2,4-ditert-butylphenyl)phosphite in an amount of 0.2 phr.

14. The composition according to claim 1, wherein the composition consists of the following components:
RPET in an amount of 95.1 wt %,
TiO₂ in an amount of 0.3 phr,
Trisodium Citrate in an amount of 1.0 phr,
PP-g-MAH in an amount of 2.0 phr,
Pentaerythritol tetrakis[3-[3,5-di-tert-butyl-4-hydroxyphenyl]propionate) in an amount of 0.2 phr,
tris(2,4-ditert-butylphenyl)phosphite in an amount of 0.2 phr and
Polyethylene wax in an amount of 1.5 phr.

15. A molded product consisting of the composition according to claim 1.

16. A method for producing a molded product, comprising placing a composition in an injection molding machine and molding the product, wherein the composition comprises:
(a) recycled polyethylene terephthalate in an amount of over 90 wt %;
(b) a nucleation agent selected from the group consisting of salts of citrate acid, salts of carbonic acid, titanium oxide and mixtures thereof in an amount of 0.2-1 phr; and
(c) an impact modifier in the form of an unsaturated organic compound selected from the group consisting of acids, anhydrides, esters and metallic salts of at least one of the following: maleic, acrylic, methacrylic, itaconic, crotonic, alpha-methyl crotonic and cinnamic, in an amount of 2-4 phr.
